(19) United States
(12) Patent Application Publication
(10) Pub. No.: US 2011/0078132 A1
(43) Pub. Date: Mar. 31, 2011

(54) FLEXIBLE INDEXING AND RANKING FOR SEARCH

(75) Inventors: Guomao Xin, Beijing (CN); Shuming Shi, Beijing (CN); Yunxiao Ma, Beijing (CN); Ji-Rong Wen, Beijing (CN)

(73) Assignee: Microsoft Corporation, Redmond, WA (US)

(21) Appl. No.: 12/570,004

(22) Filed: Sep. 30, 2009

(51) Int. Cl. G06F 17/30

(52) U.S. Cl. 707/711; 707/E17.002; 707/E17.008

(57) ABSTRACT

Described is a flexible framework for index building and document retrieval in a search environment that allows different search scenario applications to reuse index building and document retrieval code for non-scenario-specific functionality. Interfaces to various functionality of an index builder and retrieval engine are defined. An application calls the interfaces to specify custom code to perform a search scenario when needed, or use default code when non-scenario-specific functionality may be used.

### CROSS-REFERENCE TO RELATED APPLICATION

The present application is related to U.S. patent application Ser. No. ______ (attorney docket no. 327767.01), entitled “Experimental Web Search System,” filed concurrently herewith and hereby incorporated by reference.

### BACKGROUND

In web searching environments, the traditional indexing and ranking framework for searching is not very straightforward, nor is it practical for the framework to be shared by different search applications. For example, to meet the requirements of different scenarios in a codebase, switch clauses (if-then-else/if- . . . -else/if-else) need to be inserted in many places in the code.

Moreover, the differences in requirements among various scenarios may be more than that can be easily handled by switching to different routines. Different scenarios may require different data structures. Code maintenance needs to consider such requirements to ensure that different scenarios are properly handled.

As a result, search applications have different codebases, even though some non-trivial parts of them are similar. This is inefficient and makes search code maintenance difficult. For example, to add a new scenario or modify an existing scenario, the places to be modified need to be determined, with modifications made at possibly dozens of places in many files. Further, because the code for various scenarios may interact, any modification to improve one scenario cannot adversely affect other modules.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a search scenario may be implemented using some scenario-specific code to perform scenario-specific functionality, and some non-scenario-specific code of an index builder and retrieval engine for general functionality. The technology comprises an index builder and a retrieval engine, along with set of interfaces that allow calling programs to provide information and/or implement functionality as desired.

Example interfaces include an interface for specifying a document to be indexed, and an interface for specifying a document collection to be indexed. Other interfaces include an interface that when invoked transforms a document into features (e.g., in a list of hits), and an interface that when invoked transforms a document into document metadata. Still other interfaces are directed towards accessing the inverted index, e.g., an interface for adding document-related data to the inverted index, an interface for reading from the inverted index, and an interface for writing to the inverted index.

With respect to document searching, an interface associated with the retrieval engine may be used for specifying a ranking function to compute the relevance score of a given document with respect to a query. Another interface is used for specifying a retrieval strategy to generate a number of top documents with respect to a given query. Yet another interface may be used for generating a query-dependent document summarization for a document and a query.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example flexible indexing and ranking framework for use in a search environment.

FIG. 2 is a block diagram representing relationships between example interfaces for running different applications on the flexible indexing and ranking framework.

FIG. 3 shows an illustrative example of a computing environment into which various aspects of the present invention may be incorporated.

### DETAILED DESCRIPTION

Various aspects of the technology described herein are generally directed towards an indexing and retrieval framework that supports multiple scenarios in one codebase. The framework thus makes it faster and more efficient to improve search modules and evaluate them. A general idea of the framework is to decouple scenario-specific code from non-scenario-specific indexing and/or retrieval operations.

It should be understood that any of the examples herein are non-limiting. Indeed, as one example, a particular implementation having various interfaces and functions is described, however this is only one example. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and search technology in general.

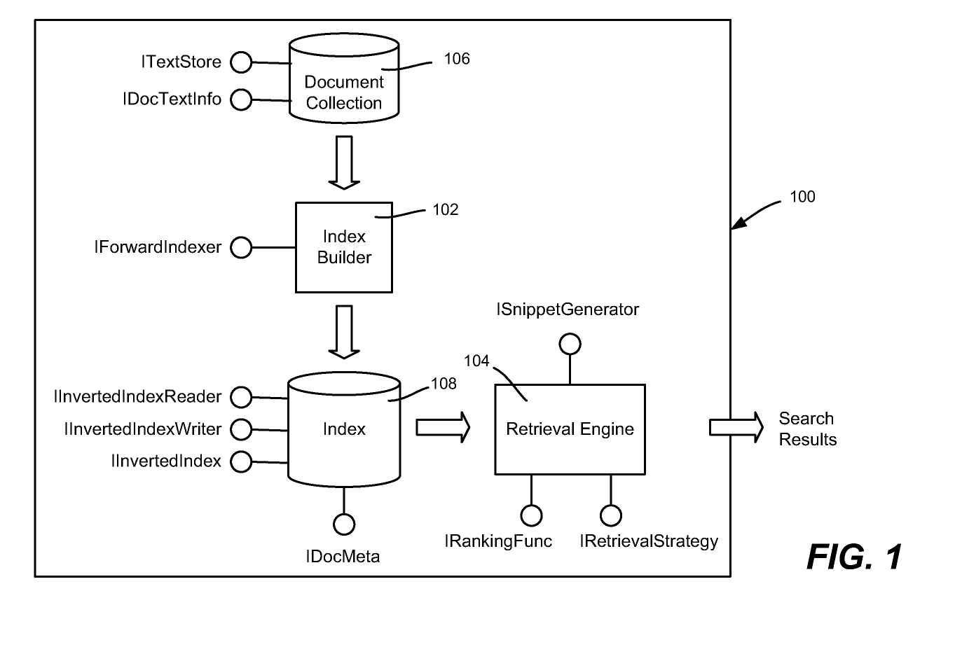

Turning to FIG. 1, there is shown an example framework 100 in which a search engine is divided into an index builder (module) 102 and a retrieval engine (module) 104. In general, the index builder 102 reads documents from a given document collection 106 and builds an inverted index 108 for those documents. Based on the inverted index, the retrieval engine 104 returns search results for received queries.

As will be understood, in this implementation the operations of the two modules may be shared by all search applications, as the index builder 102 performs operations that are common to all indexing scenarios, and the retrieval engine 104 performs scenario-independent operations of retrieving the top results with respect to a query via scenario-independent code.

As described below, certain data structures and operations of the index builder and the retrieval engine are abstracted into interfaces. Different search applications may have different implementations for one or several interfaces, while other code (e.g. framework code and some interface implementations) may be shared. Thus, any scenario-specific operations and settings are incorporated into the framework by implementing the appropriate interfaces.

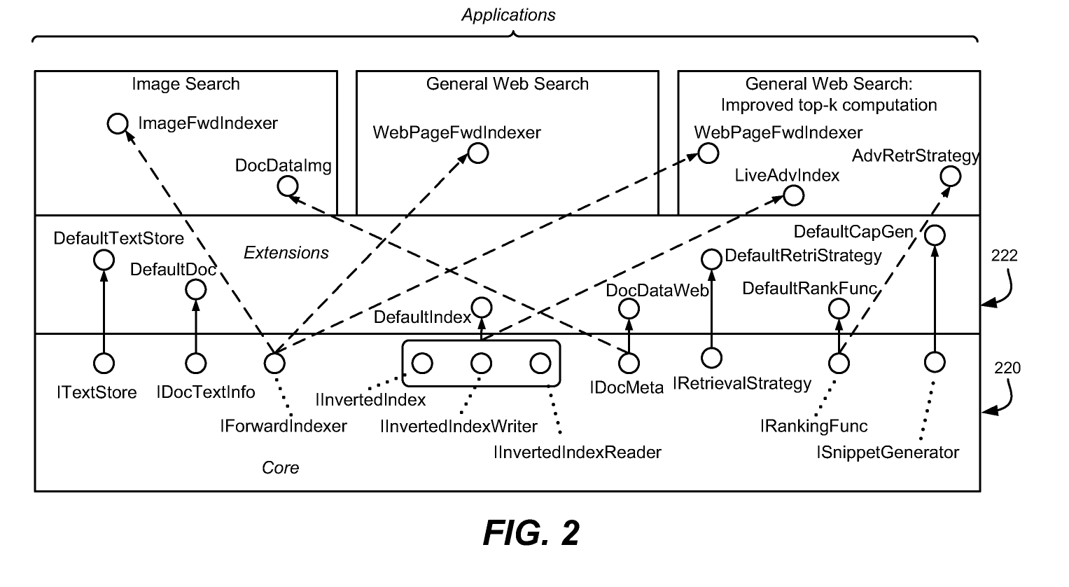

FIG. 2 shows the framework 100 in a different representation that also shows various search applications supported upon the framework. A core layer 220 contains the index builder 102 and retrieval engine 104, and also shows the corresponding interfaces.

To assist in program development, an extension layer 222 provides default implementations for the interfaces. As can be seen, implementing a search application is accomplished by customizing the implementations of some interfaces, while reusing others. This is much more efficient than developing an entire search application.

More particularly, the abstraction of data structures and operations in the indexing and retrieval process provides for customizing only the code differences needed for different search scenarios. Note however, that such data structures and/or operations may share some common characteristics. For example, the way of indexing a web page is different from the way of indexing an image. Because the common characteristics are abstracted via interfaces in the framework, different implementations of the same interface can be created for different scenarios, by placing scenario-specific operations and settings in the interface implementations corresponding to the scenario.

By way of a particular example, the aforementioned related patent application entitled “Experimental Web Search System” is able to build experimental indexes, rank documents according to experimental ranking functions, use experimental retrieval strategies and/or experimentally generate custom snippets by invoking the appropriate interfaces. For example, to test the quality of search results obtained from an experimental index that uses a new feature, the experimenter uses the interface to implement code for generating the experimental index. To test the quality of ranked results given a new ranking function, the experimenter specifies the ranking function to use via an appropriate interface.

Turning to the interfaces and their functionality, ITextStore and IDocTextInfo are the abstraction of input data for the index builder 102. ITextStore represents the document collection, and IDocTextInfo abstracts a single document in the collection. In one implementation, the index builder 102 reads the documents from a concrete ITextStore and indexes the documents one at a time:

class ITextStore
{

virtual bool Open(const std::string &strURI) = 0;
virtual bool Close( ) = 0;
virtual int NextDoc(IDocTextInfo &dti) = 0;
virtual bool HasMoreDoc( ) = 0;
virtual IDocTextInfo* CreateEmptyDoc( ) = 0;

};
class IDocTextInfo
{

virtual UINT32 GetDocId( ) const = 0;
virtual bool BeforeBeingIndexed( ) { return true; };
virtual bool AfterBeingIndexed( ) { return true; };

};

IForward Indexer abstracts the logic of transforming raw document content into document features (e.g., a bag of words). The index builder 102 invokes inverted index-related interface implementations to convert the document features into inverted index. In other words, IForwardIndexer transforms a given document (abstracted by the IDocTextInfo interface) into a list of hits (or postings), as shown in the following tables; the document metadata (abstracted by IDocMeta) of the document is also assigned via this interface. Examples of document metadata include document length, number of terms in document, static rank, and so forth.

// Transform a document into a term hit list
class IForwardIndexer
{
virtual bool ProcessDoc(
IN const IDocTextInfo &dti,
OUT HitList &hitList,
OUT IDocMeta &docMeta) = 0;
};

Hit information is represented in the following table:

struct HitInfo
{

UINT16 m_nTermId;
SIZED_STRING m_strTerm;
UINT32 m_nFieldId; //stream ID
UINT32 m_nTermPos;
UINT32 m_nTermMeta;

};
class HitList //a list of HitInfo instances
{

std::vector<HitInfo> m_hits;

};

The IInvertedIndex, IInvertedIndexReader, IInvertedIndexWriter, and IDocMeta interfaces are the abstraction of inverted index operations and data structures. By implementing these interfaces, users can generate various formats of inverted indexes used by a retrieval engine. IInvertedIndex, IIndexReader, and IIndexWriter combined together provide the primary operations of an inverted index:

class IInvertedIndex
{

virtual bool AddDoc(HitList &hitList, IDocMeta &docMeta) = 0;
virtual bool Save(const std::string &strURI) = 0;
virtual bool Clear( ) = 0;
virtual bool BeforeAddDocs(void *pReserved = NULL) { return
true; }
virtual bool BeforeSave( ) { return true; }

};
class IIndexReader
{

virtual bool Open(const std::string &strURI) = 0;
virtual bool Close( ) = 0;
virtual int NextInvertedList(OUT IInvertedList *pInvertedList) = 0;
virtual IInvertedList* GetInvertedList(const std::string &strTerm) =
0;

};
class IIndexWriter
{

virtual bool Open(const std::string &strURI) = 0;
virtual bool Close( ) = 0;
virtual bool Flush( ) = 0;
virtual bool AddInvertedList(IN const IInvertedList *pInvertedList) =
0;

};

The IRankingFunc interface represents the logic for calculating the relevance score of a given document with respect to a query. The IRetrievalStrategy interface abstracts the logic of generating the top N documents with respect to a given query:

class IRetrievalStrategy
{

virtual bool Init(

const std::string& strConfigFileName,
IIndexReader *pIndex,
IDocMetaTable *pDocMetaTable) = 0;

virtual bool SetRankingPreferences(

IRankingFunc *pRankingFunc,
IRankingParams *pParams,
IRankingOptions *pOptions) = 0;

virtual bool ProcessQuery(

const std::string &strQuery,
OrderedDocList *pDocList) = 0;

};
class IRankingFunc
{

virtual bool BeginQuery(QueryProcStuff *pQueryProcStuff) = 0;
virtual bool EndQuery(QueryProcStuff *pQueryProcStuff) = 0;
virtual bool EvaluateDoc(

QueryProcStuff *pQueryProcStuff,
DocProcStuff *pDocProcStuff,
DocProcResults *pDocScores) = 0;

};

The ISnippetGenerator allows for different ways to generate snippets (query-dependent document summarizations). To this end, given a document and query, the implementation of ISnippetGenerator generates snippet or query-dependent document summarization:

class ISnippetGenerator
{
virtual bool GenerateSnippet(

const SnippetGenStuff *pStuff,
QueryProcResults::Item &resultItem) = 0;

};

The snippet is provided via the following structure:

struct SnippetGenStuff
{

const IQuery *m_pQuery;
const IDocTextInfo *m_pDocTextInfo;
std::string m_strOptions;

};

### Exemplary Operating Environment

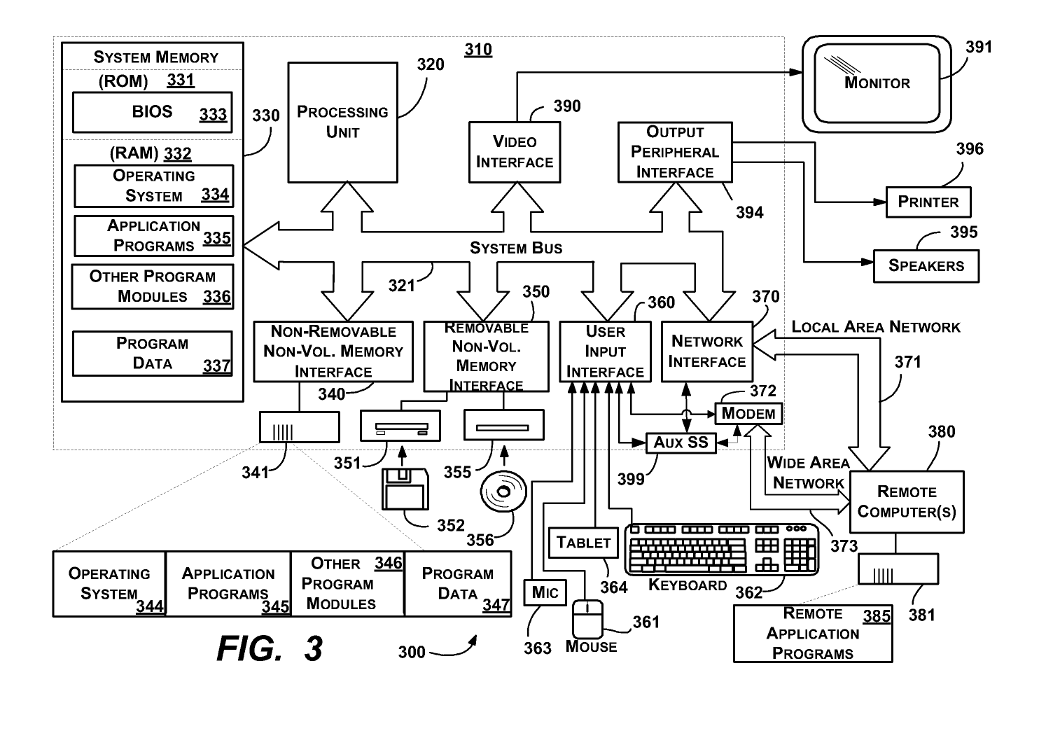

FIG. 3 illustrates an example of a suitable computing and networking environment 300 on which the examples of FIGS. 1 and 2 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a system comprising, a search-related framework including an index builder, a retrieval engine, and a set of interfaces that allow calling programs to implement a search scenario using some scenario-specific code and some non-scenario-specific code of the index builder and retrieval engine.

2. The system of claim 1 wherein the set of interfaces that allow calling programs to implement a search scenario using some non-scenario-specific code includes interfaces associated with an extension layer that provides default implementations for some interfaces.

3. The system of claim 1 wherein the set of interfaces includes an interface for specifying a document to be indexed.

4. The system of claim 1 wherein the set of interfaces includes an interface for specifying a document collection to be indexed.

5. The system of claim 1 wherein the set of interfaces includes an interface that transforms a document into a list of hits.

6. The system of claim 1 wherein the set of interfaces includes an interface that transforms a document into document metadata.

7. The system of claim 1 wherein the set of interfaces includes interfaces for accessing an inverted index.

8. The system of claim 7 wherein the interfaces for accessing the inverted index comprises an interface for adding document-related data to the inverted index, an interface for reading from the inverted index, and an interface for writing to the inverted index.

9. The system of claim 1 wherein the set of interfaces includes an interface for specifying a ranking function that computes the relevance score of a given document with respect to a query.

10. The system of claim 1 wherein the set of interfaces includes an interface for specifying a retrieval strategy to generate a number of top documents with respect to a given query.

11. The system of claim 1 wherein the set of interfaces includes an interface for generating a query-dependent document summarization for a document and a query.

12. In a computing environment, a system comprising, an index builder that indexes a document collection in which the document collection is associated with interfaces that identify the document collection and identify a document to be indexed, the index builder including an interface that when invoked transforms document content into features for indexing in an index, the index including interfaces for accessing index data therein, and a retrieval engine including a retrieval engine interface set that when invoked specify search-related operations to perform with respect to the index.

13. The system of claim 12 further comprising an extension layer that provides default implementations for the interfaces.

14. The system of claim 12 wherein the interfaces for accessing the inverted index data comprises an interface for adding document-related data to the inverted index, an interface for reading from the inverted index, and an interface for writing to the inverted index.

15. The system of claim 12 wherein the retrieval engine interface set includes an interface for specifying a ranking function that computes the relevance score of a given document with respect to a query.

16. The system of claim 12 wherein the retrieval engine interface set includes an interface for specifying a retrieval strategy to generate a number of top documents with respect to a given query.

17. The system of claim 12 wherein the retrieval engine interface set includes an interface for generating a query-dependent document summarization for a document and a query.

18. In a computing environment, a system comprising, a core layer including set of interfaces that allow calling programs at an application layer to implement a search scenario, including by using the interfaces to implement some scenario-specific functionality, some non-scenario-specific functionality of an index builder to build an index, and some non-scenario-specific functionality of a retrieval engine.

19. The system of claim 18 further comprising an extension layer that provides default implementations for the interfaces.

20. The system of claim 18 wherein the interfaces to implement some non-scenario-specific functionality of the retrieval engine include an interface for specifying a ranking function, an interface for specifying a retrieval strategy, or an interface for generating a query-dependent document summarization for a document and a query, or any combination of an interface for specifying a ranking function, an interface for specifying a retrieval strategy, or an interface for generating a query-dependent document summarization.
